(19) United States
(12) Patent Application Publication
(10) Pub. No.: US 2017/0024544 A1
(43) Pub. Date: Jan. 26, 2017

(54) Systems and Methods For Monitoring Compliance With Chronic Disease Prevention Programs

(71) Applicant: Solera Health, Inc., Phoenix, AZ (US)

(72) Inventor: Brenda Schmidt, Phoenix, AZ (US)

(21) Appl. No.: 14/808,956

(22) Filed: Jul. 24, 2015

(51) Int. Cl. G06F 19/00

(52) U.S. Cl. CPC G06F 19/3481; G06F 19/322; G06F 19/328

(57) ABSTRACT

Systems and methods are provided for facilitating the delivery of chronic disease prevention programs. The method includes: receiving an electronic record for a participant; interrogating a database of CBOs and selecting a particular CBO to provide a chronic disease prevention program for the participant; enrolling the participant in the program; updating the electronic record as the participant progresses through the program; submitting a claim to a health plan administrator upon completion of the program by the participant; and transmitting payment to the selected CBO.

### TECHNICAL FIELD

The present invention relates, generally, to systems and methods for linking primary care providers with community based prevention programs and, more particularly, to an on-line platform for monitoring patient compliance with prevention programs, and for submitting reimbursement claims to health plans on behalf of community based organizations.

### BACKGROUND

Recent changes in the U.S. health care system offer an opportunity to improve population health. As described in the January, 2014 article entitled “Twin Pillars of Transformation: Delivery System Redesign and Paying for Prevention”, available at www.healthyamericans.org, population health offers better care for patients, better health for the population, and lower healthcare costs by reversing the escalating epidemic of chronic diseases such as obesity, diabetes, and cardiovascular disease. A key component of population health involves linking clinical care with community based prevention programs and related social services.

Despite population health's emphasis on community, many approaches to population health do not effectively integrate community-based providers as an adjunct to primary care. The Journal for Public Health Management and Practice, “Population-Based Health Principles in Medical and Public Health Practice” (http://journals.lww.com/jphmp/Abstract/2001/07030/Population Based Health Principles in Medical and.12.aspx), notes that traditional medical education, research, and practice have focused on the care of the individual. Shifting the emphasis to embracing population-based health principles can have a greater effect on long term health and wellness, particularly in the prevention of chronic disease.

In this regard, Diabetes affects 29 million Americans and another 86 million American adults are estimated to have pre-diabetes, a condition that puts them at high risk for developing type 2 diabetes mellitus (T2DM). Between 15% and 30% of individuals with pre-diabetes who are overweight will develop T2DM within 5 years. Without prevention, 1 out of every 5 American adults will develop T2DM by 2025, and 1 out of 3 by 2050. T2DM has a disparate impact on racial and ethnic minorities. The risk of developing T2DM is 77% higher among African Americans, 66% higher among Latinos, and 18% higher among Asian Americans compared with Whites. Native Americans are even more disparately affected by diabetes. Nationwide, 16% of Native American adults are diagnosed with the disease, with rates soaring as high as 33% for some Tribal communities in the Southwest.

In addition to a significant human toll, the financial cost of diabetes is staggering. In 2012, the total estimated cost of diabetes in the United States was $245 billion. The growth in the prevalence of T2DM predicts that direct medical costs will soar in the next 2 decades.

Fortunately, T2DM and many other chronic diseases are largely preventable. An important factor in reversing these epidemics is increased access to evidence-based prevention programs for populations at high risk for developing the disease. For example, the National Diabetes Prevention Program (National DPP) is the “gold standard” for diabetes prevention, with proven outcomes in multiple randomized controlled trials. The National DPP is a year-long community-based program delivered in a group-based setting in the community or more recently, delivered virtually (on line) supported by a trained lifestyle coach. The program helps people modify their eating and physical activity habits and learn how to sustain lifestyle changes over time with a modest 5% to 7% weight loss goal. The National DPP has been shown to reduce the risk of developing T2DM by 58% for adults age 25 years and older with prediabetes, and by 71% for adults older than 60 years.

Scaling the National DPP and other chronic disease prevention programs in communities across the nation is an important step in combating the rise in chronic disease. However, effective promotion of population health, including the prevention and control of chronic diseases, requires effective collaboration among primary care providers, community based organization, and health plans (the ultimate payor).

Approximately 625 organizations have been granted pending or full recognition status as National DPP providers by the Centers for Disease Control and Prevention (CDC) (http://www.cdc.gov/diabetes/prevention/recognition). However, disparate community-based and virtual DPP providers are not supported through a coordinated approach to patient identification, referrals, program delivery, and payment. At present, healthcare providers supply their eligible patients with a list of organizations offering the National DPP, relying on the patient to follow up directly with a provider organization. Unfortunately, these lists quickly become outdated due to the welcome proliferation of organizations offering the National DPP, including virtual DPP programs.

Moreover, this type of “opt-in” approach tends to result in significantly lower enrollment, in part because prevention programs offered by community-based organizations are typically not covered by most health insurance plans. Moreover, community based organizations often lack the operational infrastructure and systems necessary to manage and store large sets of data, and are not equipped to meet privacy and security standards required by the Health Insurance Portability and Accountability Act and the Health Information Technology for Economic and Clinical Health Act.

More recently, insurers have begun to adopt the National DPP as a covered benefit for their members. However, most National DPP providers do not have the infrastructure in place to submit medical claims for their services. Moreover, it would be unduly cumbersome and cost prohibitive for health plans to independently contract with each community-based or virtual National DPP provider.

Systems and methods are thus needed which overcome these limitations. Various desirable features and characteristics will also become apparent from the subsequent detailed description and the appended claims, taken in conjunction with the accompanying drawings and this background section.

### BRIEF SUMMARY

The present invention provides systems and methods for effectively integrating a variety of chronic disease prevention stakeholders to support program delivery by and reimbursement to the community based organization (CBO). Information technology capacity is a core function of the integrator. In an embodiment, a cloud based, software-as-a-service (SaaS) platform supports evidence-based chronic disease prevention and control programs that are delivered by community-based organizations. The platform and underlying databases facilitate management of the prevention programs (typically classes), data collection (typically evidence based metrics such as the participant's weight), and reimbursement by payers (typically health plans).

Through direct contracting with health plans, the integrator serves as a clearinghouse and provides the operational infrastructure and technology needed to broadly scale prevention programs such as the National DPP, and coordinates patient qualification and enrollment, data privacy and security, reporting, delegate oversight, physician referrals, and compliance.

Various embodiments of the present invention relate to systems, methods, and on-line platforms for: i) the seamless integration of data among clinical providers (doctors and hospital groups), CBOs, and Health Plans; ii) providing a sustainable financial model for CBOs; iii) a medical record that “lives” in the community and which is dynamically updated by class instructors (coaches); iv) a portal for facilitating prevention programs which can be accessed by the stakeholders; and v) various algorithms for determining whether a participant is eligible, qualified, enrolled, and compliant with various prevention programs

Various other embodiments, aspects and features are described in greater detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a schematic block diagram of an exemplary system for facilitating the provision of disease prevention programs in accordance with various embodiments;

FIG. 2 is a schematic block diagram of an integrator including an integrator computer module having a processor, a database of CBOs, and a database of participants received from a plurality of sources in accordance with various embodiments;

FIG. 3 is a block diagram of a provider, a plan administrator, a CBO, and an integrator in accordance with various embodiments;

FIG. 4 is a process flow diagram illustrating an exemplary use case involving the provider 302, plan administrator, CBO, and an integrator of FIG. 3 in accordance with various embodiments;

FIG. 5 is a flow chart illustrating a process for maintaining compliance with a minimum biometric population in accordance with various embodiments; and

FIG. 6 is an exemplary screen shot illustrating summary enrollment data for a list of program sponsors in accordance with various embodiments;

FIG. 7 is a screen shot illustrating detailed information for a particular program sponsor in accordance with various embodiments;

FIG. 8 is a screen shot illustrating detailed information for an individual participant in accordance with various embodiments;

FIGS. 9-11 are screen shots illustrating detailed information for a particular disease prevention program (class schedule) in accordance with various embodiments; and

FIG. 12 is a screen shot illustrating detailed information for the participants enrolled in a particular class in accordance with various embodiments;

FIG. 13 is a screen shot illustrating detailed information for a list of classes and corresponding program sponsors in accordance with various embodiments; and

FIG. 14 is a screen shot illustrating detailed information for a plurality of participants including identifying information, biometric information, status information, personal information and other notes in accordance with various embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Various embodiments of the present invention relate to systems and methods for linking primary care providers with CBOs to provide disease prevention and other programs. In the context of this disclosure, these programs include at least the following categories: i) lifestyle/prevention (pre-chronic); ii) chronic disease (e.g., congestive heart failure, arthritis, cavity prevention, falls prevention, diabetes, back pain, COPD, hypertension, cardiovascular disease); iii) behavioral health (e.g., addiction, domestic violence, anger management, depression, anxiety); and iv) pharmaceuticals.

Moreover, it is known that a relatively small percentage of the population (e.g., 20-25%) consumes a disproportionate percentage of total health care costs (e.g., 70-80%), largely as a result of the treatment of chronic diseases such as diabetes and hypertension. By identifying pre-chronic disease candidates before they enter the chronic stage, and delivering prevention programs to these candidates by lower cost lay instructors and coaches, as opposed to physicians and nurses, overall population health may be improved while reducing the overall cost of delivery. The present invention provides an integrator configured to effectively facilitate the delivery of prevention programs, and at the same time provide a sustainable model for the CBOs by facilitating payment to the CBOs from health care plan administrators.

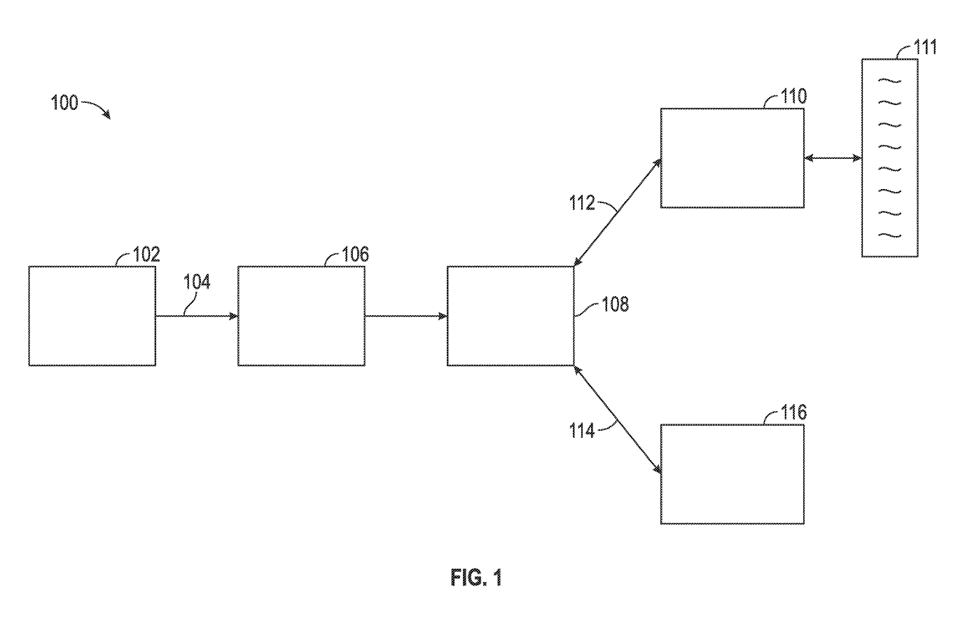

Referring now to FIG. 1, a block diagram of a system 100 for facilitating the provision of disease prevention programs illustrates a clinical provider 102 (doctor, hospital) referring 104 a patient (also referred to herein as a program participant) 106 to an integrator 108. The integrator interrogates a database in of CBOs and recommends a best fit program no based on, inter alia, the schedules and locations of the participant and best fit CBO, respectively. As described in greater detail below, the integrator 108 monitors 112 the participant's compliance with the program, and processes a claim for payment 114 from a health plan administrator (also referred to herein as the Plan or Payer) 116.

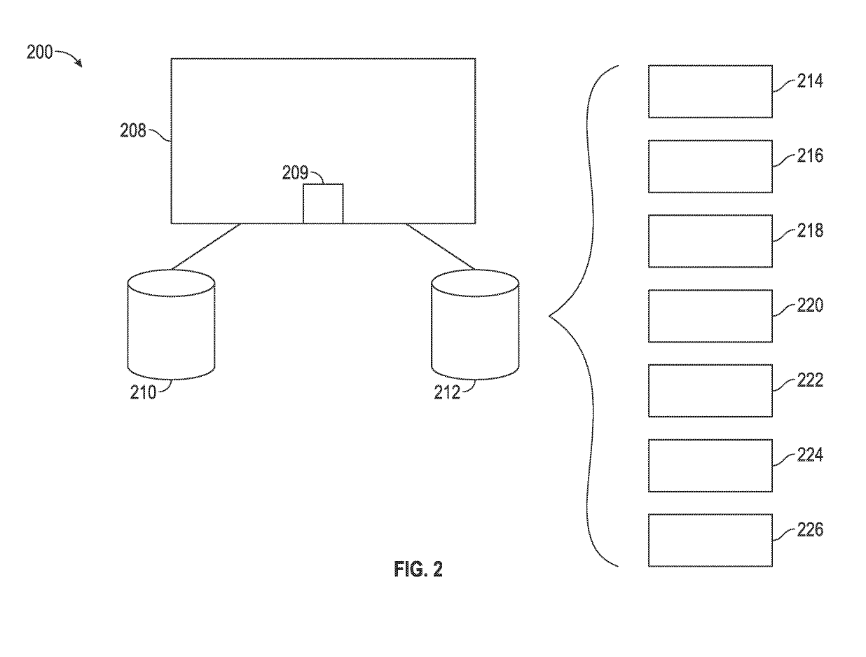

Referring now to FIG. 2, the integrator may be configured to perform any number of the various functions and tasks described herein. For example, a database system 200 illustrates an integrator computer module 208, including a processor or processing system 209, configured to maintain a first database 210 of CBOs (some of which may also be clinical providers), and a second database 212 of participants; that is, the integrator builds and manages a vast relational database of health plan members. The integrator 208 may be configured to recruit participants into the database 212 using at least the following sources (also referred to as entry vectors): employers 214, medical providers 216, health systems 218, health plans 220, sell-referral 222, network providers 224, and CBOs 226.

The integrator 208 may be configured to import data sets from the foregoing vectors, stratify the data, and identify individuals that fit a profile or otherwise have a need for various programs. In contrast, CBOs are not typically equipped with the data security systems and protocols (e.g., HPPA compliant systems) or other processing infrastructure needed to securely manage large data sets.

With continued reference to FIG. 2, employers 214 may be brought into the system based on the fact that an employer's benefits package (e.g., an employee health insurance policy) has been revised to cover prevention programs.

Medical providers 216 may include doctors, groups of primary care physicians (PCP) whether geographically centralized or dispersed, pharmacists, and other health care professionals having a database of potential candidates for prevention programs.

Health systems 218 may include hospitals, hospital groups, primary and critical care facilities, nursing homes, rehabilitation centers, and outpatient facilities.

Health plans 220 may include health care insurance companies and their subsidiaries such as, for example, Blue Cross/Blue Shield™ (BCBS), Aetna™, UnitedHealth™, Kaiser Foundation™, Humana™, and Cigna™.

Sell-referrals 222 may include individuals logging on to the integrator's web-site or other electronic portal, or responding to emails or other correspondence from the integrator.

Network providers 224 may include faith-based, community, non-profit, fraternal, social, athletic, and civil organizations such as Weight Watchers™, YMCA™ and YWCA™.

CBOs 226 may include county and community organizations, mental health services, and other social service agencies.

The foregoing sources may submit aggregate data to the integrator, whereupon the integrator analyses the data to determine eligibility and make program recommendations respecting qualifying participants.

In an alternate embodiment, participants may be recruited into the system (i.e., into the integrator's database of participants) because a health plan initiates a call, email, or other communication to a patient. Those skilled in the art will appreciate that a health plan may be triggered to reach out to a patient by patient costs exceeding a predetermined threshold, an emergency room visit, a claim for payment, an indication that the patient is not taking medications as prescribed, or other out of profile event or circumstance.

Moreover, in some circumstances it is advantageous to monitor the manner in which a participant enters the system. In particular, current protocols established by the Center for Disease Control (CDC) require that at least a certain percentage (e.g., 50%) of patients to enter the system by way of biometrics such as a blood test or other biometric, or a CPT code. In this regard, a Current Procedural Terminology (CPT) code set is a medical code set maintained by the American Medical Association through the CPT Editorial Panel. The remaining participants may enter the system through soft protocols such as surveys, questionnaires, or other informal mechanisms. In this way the data set defined by the participants may be deemed “valid” and, hence, credible, by the CDC.

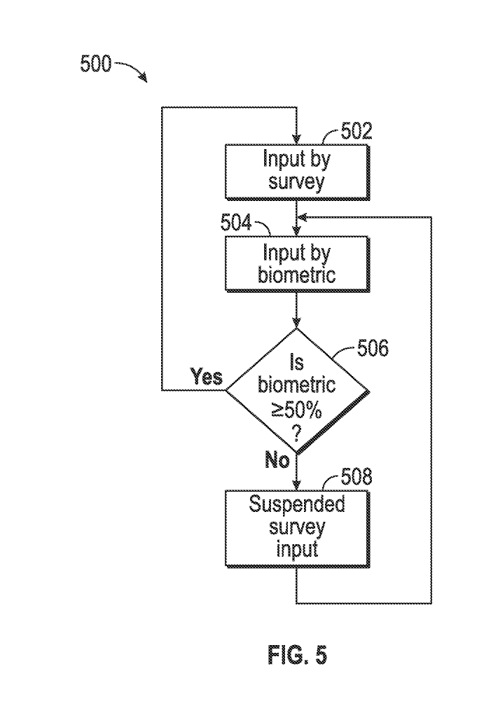

In an embodiment, the system may be configured to algorithmically monitor the 50% biometric threshold in real time, so that if a particular plan, CBO, or other entity has an associated patient population which falls below 50%, the system can trigger request participants to obtain laboratory or other biometric data so that they remain CDC compliant. Alternatively, the system may be configured to temporarily suspend accepting new participants via survey until the biometric population again exceeds the 50% threshold. FIG. 5 is a flow chart illustrating an exemplary method of monitoring the 50% biometric performance metric.

More particularly and with momentary reference to FIG. 5, a process 500 for maintaining real time, steady state compliance with a minimum (e.g., 50%) biometric population within the participant data base includes inputting new participants (Task 502) using surveys, questionnaires, interviews, email requests, or other non-biometric modalities. New participants may also be introduced into the system (Task 504) using biometric modalities such as blood test, glucometer readings, or other laboratory results. The system polls the participant database to determine whether the percentage of biometric-based participants satisfies a predetermined threshold (Task 506). If so (“Yes” branch from Task 506), the system permits new participant input by either modality (biometric and non-biometric). If, on the other hand, the percentage of biometric-based participants does not satisfy the threshold (“No” branch from Task 506), the system may temporarily suspend inputting new participants using surveys or other non-biometric techniques (Task 508), and continue adding new participants using only biometric techniques (Task 504) until the threshold is again satisfied.

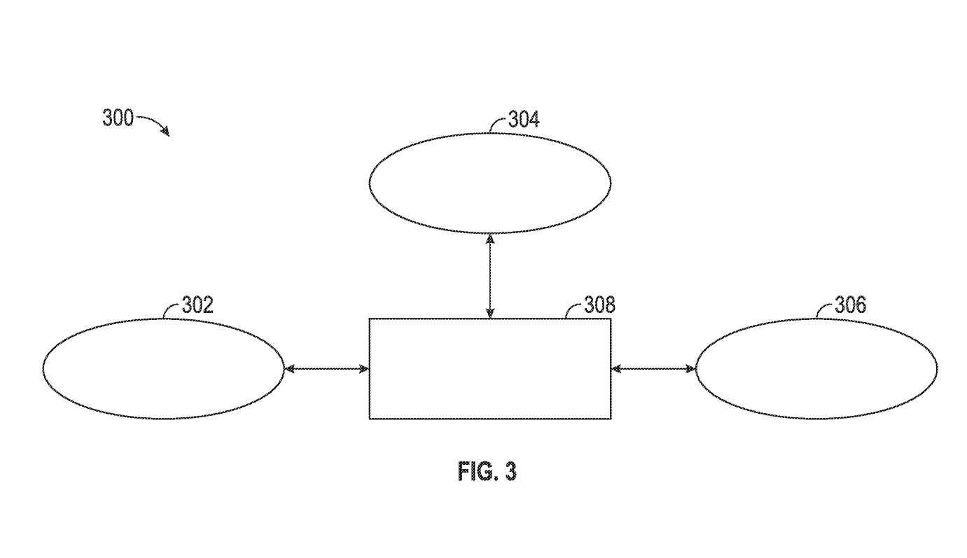

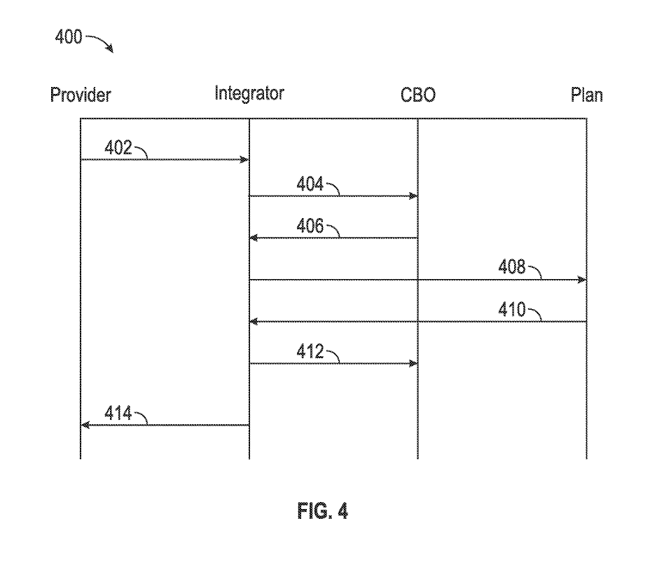

FIG. 3 is a block diagram 300 and FIG. 4 is a process flow diagram 400 illustrating an exemplary use case involving a provider 302, a plan administrator 304, a CBO 306, and an integrator 308. More particularly, a provider (or other entry vector described above) refers a participant to an integrator (step 402), whereupon the integrator identifies an appropriate CBO and facilitates enrolling the participant in a prevention program offered by the CBO (step 404). If the participant is already affiliated with a particular health plan, the integrator may permit the health plan to designate a preferred provider (e.g., Weight Watchers) for one or more prevention programs. Alternatively, the integrator can define he network of CBOs. As the participant progresses through the program, the CBO updates the participant's record within a shared database maintained by the integrator (step 406).

In an embodiment, the integrator may provide an interactive software tool for use by the CBOs to facilitate the integration process, for example, by allowing CBOs to enter participant data (e.g., attendance, body weight, and the like) directly into participant records maintained by the integrator. In an embodiment, such an interactive software tool may include the Maestro™ program available from Viridian′ Health Management located in Phoenix, Ariz.

Upon completion of the prevention program or, alternatively, at predetermined milestones (described in greater detail below), the integrator submits a claim for payment to the plan (step 408). The plan makes payment on the claim o the integrator (step 410), whereupon the integrator makes partial or full payment to the CBO (step 412), reserving for itself (the integrator) compensation for facilitating and managing the process. The integrator may then report back to the provider confirming successful completion of the program by the participant or, alternatively, otherwise reporting the status if the prevention or other program was not successfully completed (step 414). In this way the provider can report aggregate quality metrics regarding the provider's performance to the plan and to Medicare/Medicaid agencies.

In accordance with various embodiments, the integrator effectively maintains a dynamic medical record for each participant, and provides role based (e.g., a permission hierarchy) access to the record to the CBOs.

Once a participant is entered into the database 212 (FIG. 2), each patient may be characterized by 1 of 6 states for a particular prevention program: i) pending qualification; ii) qualified; ii) pending enrollment; iv) enrolled; v) discharged; and vi) not eligible. By way of non-limiting example, some prevention programs need to know the ethnicity of a participant in order to qualify the participant for the program. Thus, a participant can transition from “pending qualification” to “qualified” once the ethnicity information is received. In this regard, a Caucasian may require a body mass index (BMI) of 24 or higher to be eligible for a diabetes prevention program, but an Asian may only require a BMI of 22 to be eligible. By way of further illustration, if it is determined that a participant is already diabetic, that person would be deemed “not eligible” for pre-diabetes prevention, inasmuch as they are already in the chronic disease stage and, hence, not eligible for a prevention program.

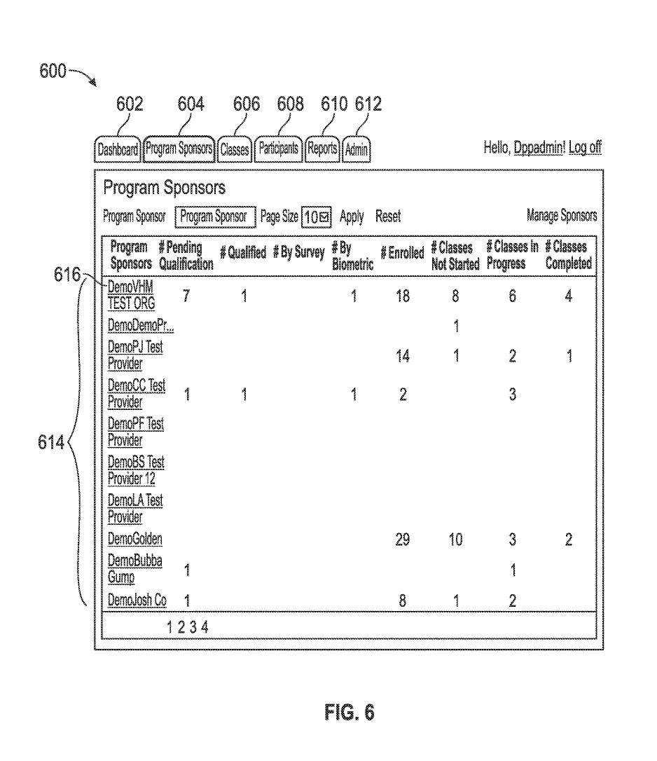

Referring now to FIGS. 6-14, various aspects of an exemplary user interface for implementing the present invention will now be described. With particular reference to FIG. 6, a screen shot boo includes a Dashboard tab 602, a Program Sponsors tab 604, a Classes tab 606, a Participants tab 608, a Reports tab 610, and an Admin tab 612. In particular, the dashboard tab 602 may be used to access graphical summaries of selected data sets.

With continued reference to FIG. 6, the Program Sponsors tab 604 allows an administrator to view a list 614 of program sponsors, such as, for example, Weight Watchers, YWCA, and the like. The summary data indicates, for each program sponsor, the number of participants pending qualification for a particular program, the number of qualified participants, and indicates the number of participants that entered the database through a survey and via biometric information. The summary further indicates, for each program sponsor, the total number of enrolled participants, and the number of classes which have not yet started, are in progress, and have been completed. Additional detail regarding a particular program sponsor 616 is described below.

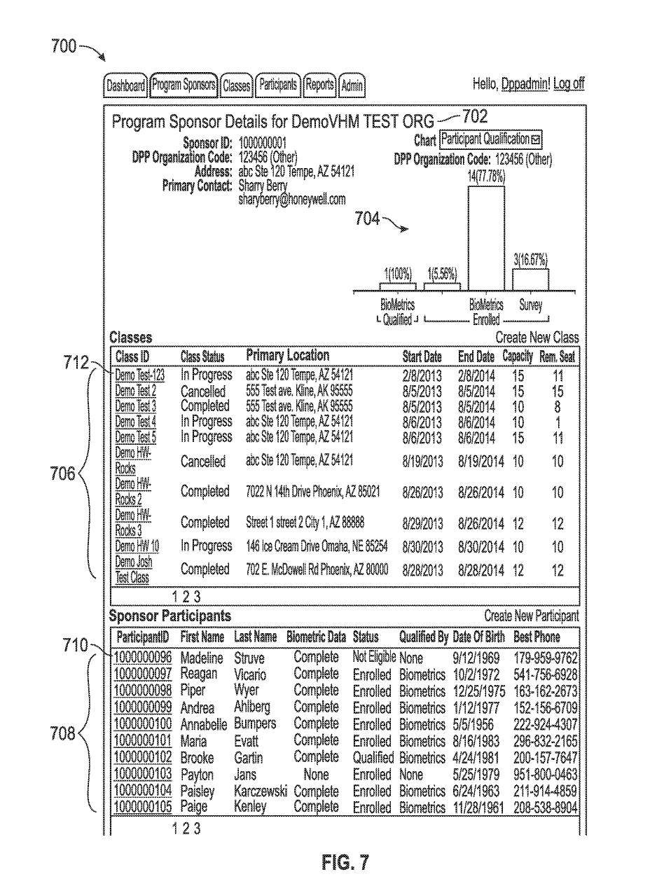

FIG. 7 is a screen shot 700 illustrating detailed information for a particular program sponsor 702 (corresponding to program sponsor 616 of FIG. 6). More particularly, screen shot 700 illustrates a visual summary 704 indicating the number of enrolled and qualified participants, and the relative percentages of enrolled participants who entered the system via biometrics and surveys, respectively. In addition, a list of classes 706 includes, for each class, the class status (e.g., in progress, cancelled, completed, scheduled but not yet started), the location (e.g., street address), the start and end dates, the total capacity, and number of available seats still available (Rem. Seats). In this way, the integrator can efficiently and effectively link participants to classes by comparing the participant's location and schedule to the location and schedules of available classes (prevention programs).

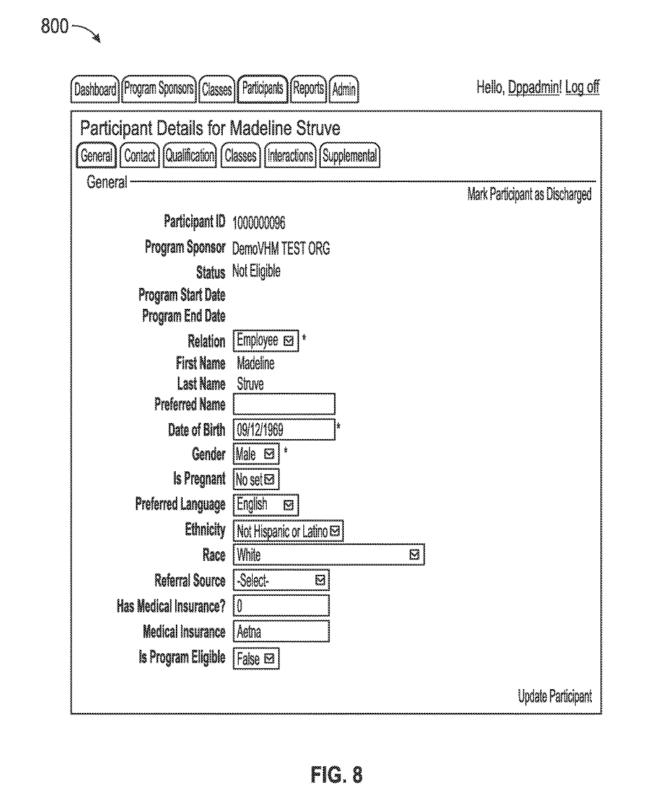

The screen shot 700 further includes a list 708 of participants associated with the program sponsor's classes. The list 708 suitably includes, for each participant, the participant's status (e.g., enrolled, qualified, not eligible), the status pf the participant's biometric data (e.g., completed), and various personal information such as birth date and contact information (e.g., email address and telephone number). Clicking on a particular individual participant 710 reveals detailed information for that individual, as illustrates in the screen shot 800 of FIG. 8.

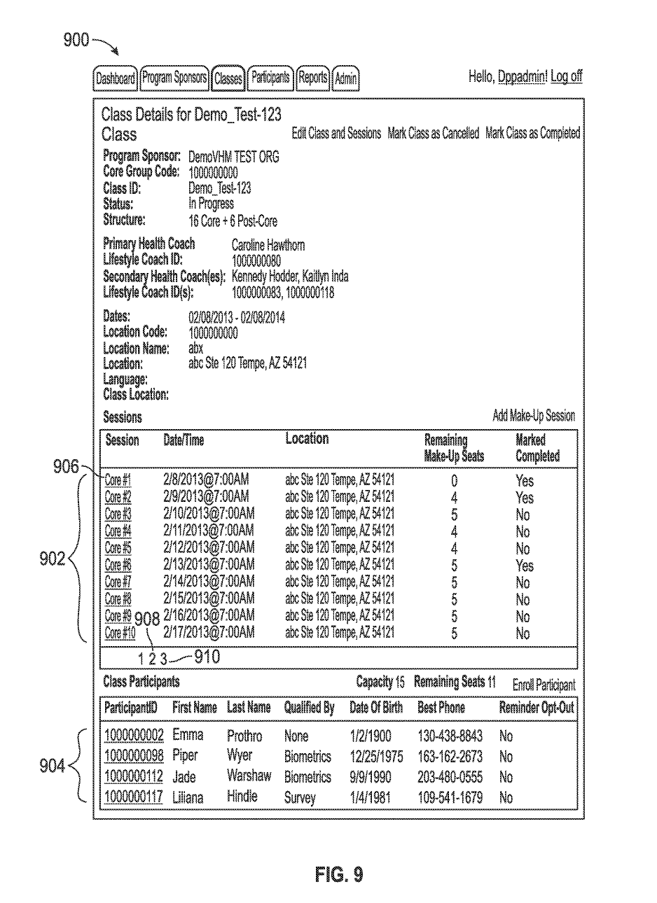

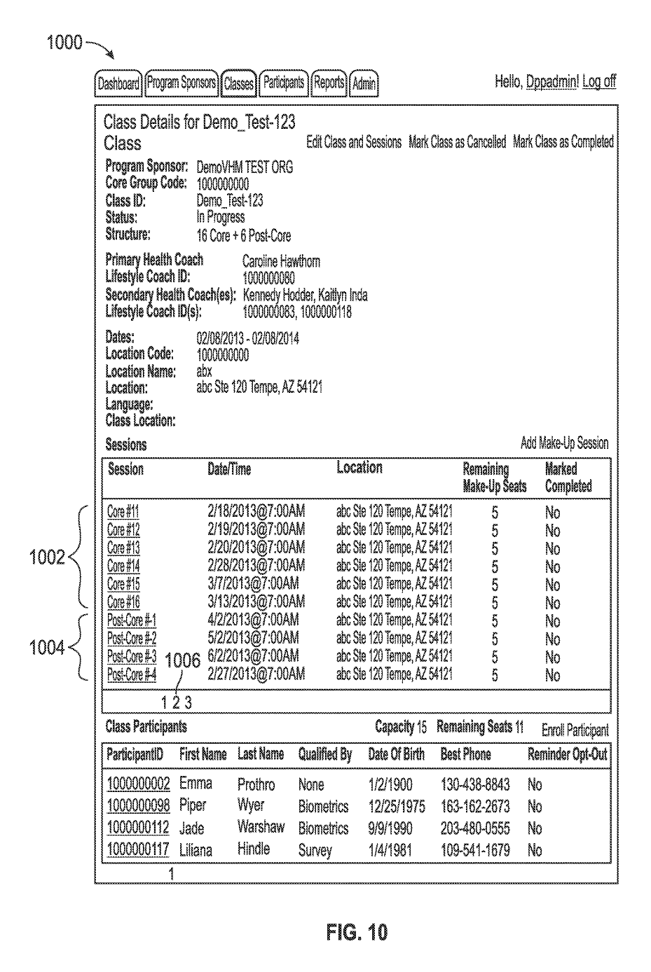

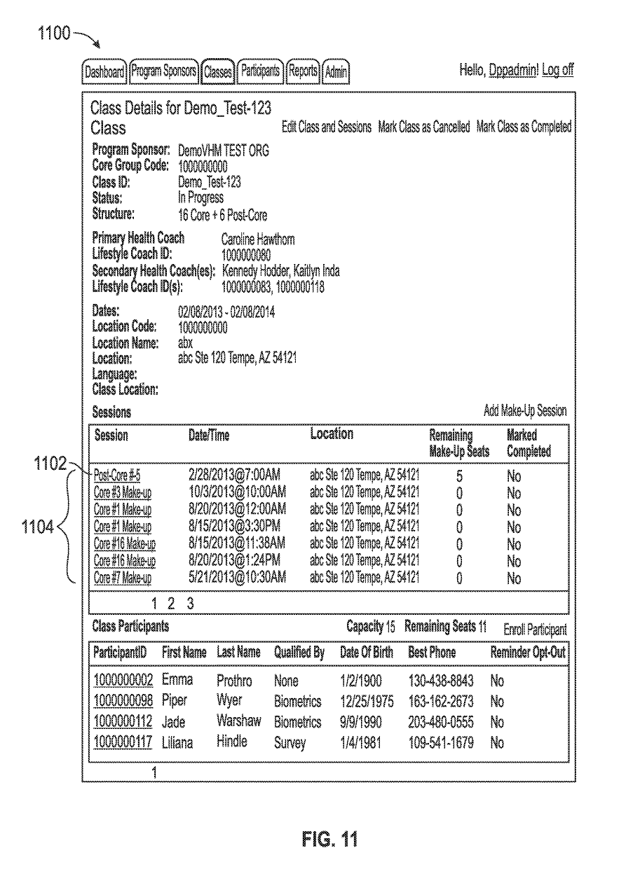

With momentary reference to FIG. 7 and referring now to FIG. 9, clicking on a particular prevention program 712 (FIG. 7) reveals detailed information for that class, as shown in screen shot 900. More particularly, screen shot 900 includes a first portion 902 of a class schedule for a particular prevention program. A second portion of the class schedule may be revealed by selecting a second page icon 908 (corresponding to FIG. 10), and a third portion of the class schedule may be revealed by selecting a third page icon 910 (corresponding to FIG. 11). The screen shot 900 also includes a list 904 of participants enrolled in the selected class.

With continued reference to FIG. 9, the first portion 902 of a class schedule includes the dates, time, and location for the first ten core segments of a program. FIG. 10 is a screen shot 1000 depicting six additional core segments 1002 and four post core segments 1004. FIG. 11 is a screen shot 1100 depicting an additional post core segment 1102 and any number of make-up segments 1104. In an embodiment, the program includes sixteen weekly classes (core #1-16), followed by five monthly classes (post core #1-5). Alternatively, the program may consist of any desired combination of classes scheduled at any desired intervals (daily, weekly, bi-weekly, monthly, and the like).

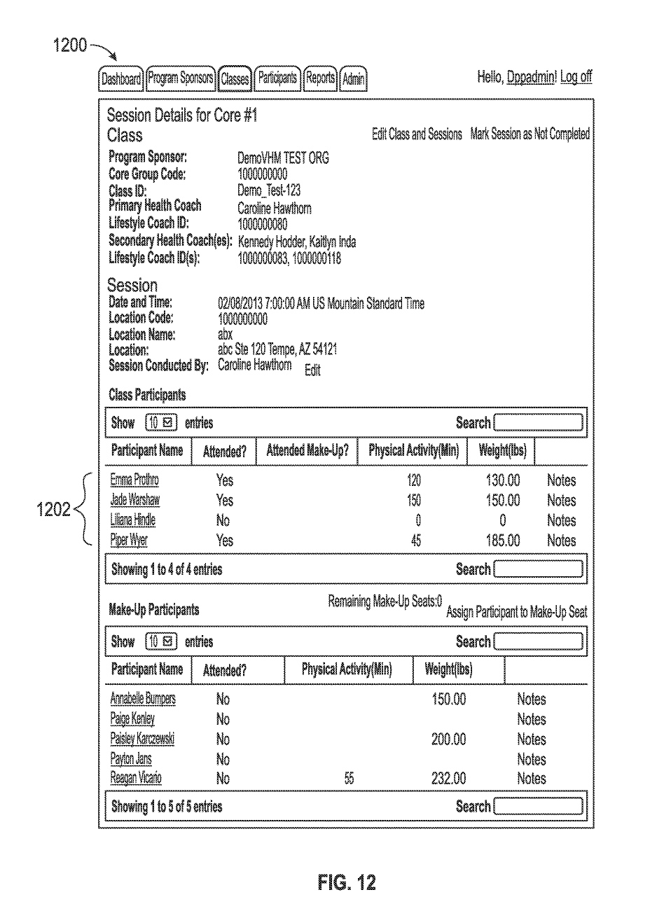

Referring again to FIG. 9, clicking on a particular class 906 reveals details of that class' participants, for example, as shown in a screen shot 1200 of FIG. 12. In particular, the screen shot 1200 includes, for each of a plurality of participants 1202, in indication of whether the participant in fact attended the class and, if so, the participant's weight, level of physical activity (e.g., expressed in minutes), and any other relevant parameters or metrics. In an embodiment, a class instructor (coach) may access the interactive software tool shown in FIG. 6 et seq. to enter information into the various fields. Alternatively, the tool may be configured to permit participants to enter biometric and other information, as appropriate.

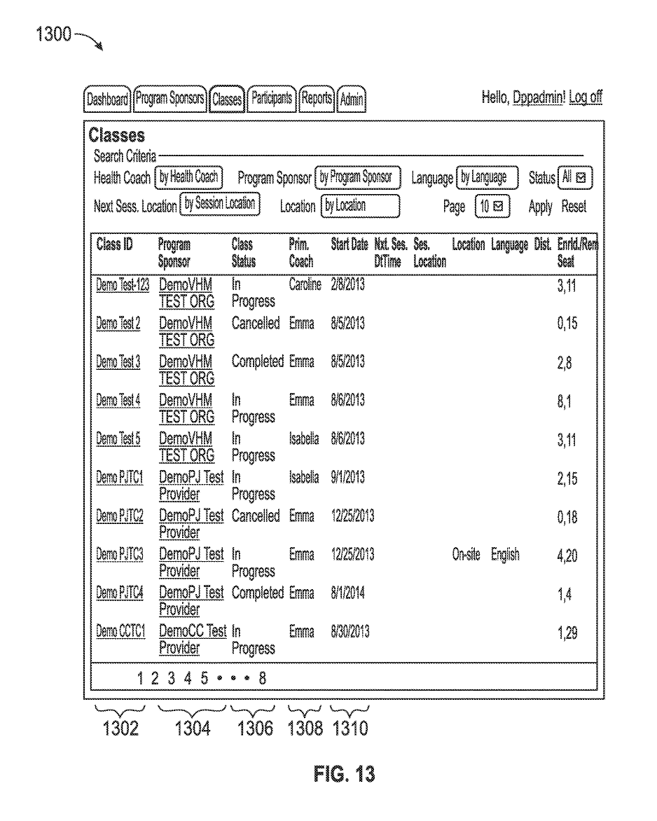

FIG. 13 is a screen shot 1300 depicting details associated with the classes tab 606 of FIG. 6. More particularly, the screen shot 1300 includes a list of classes 1302, corresponding program sponsors 1304 and, for each class, a status field 1306 (e.g., in progress, canceled), a start date 1310, and the instructor or primary coach 1308.

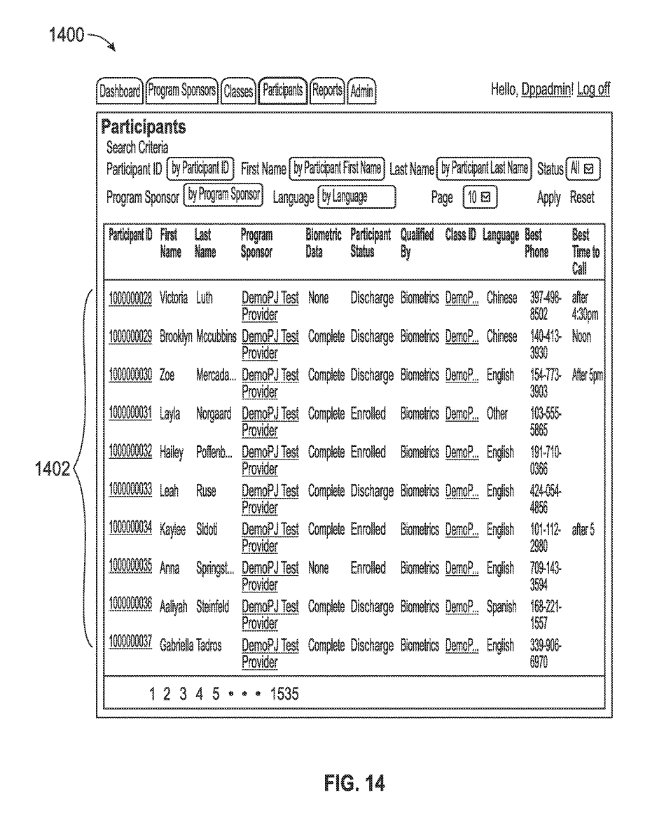

FIG. 14 is a screen shot 1400 depicting details associated with the participants tab 608 of FIG. 6. More particularly, the screen shot 1400 includes, for each of a plurality of participants 1402, identifying information, biometric information, status information, personal information (e.g., preferred language) and any other notes which may have been entered into the system entered by a coach or administrator.

A method performed by a computer system is thus provided for facilitating the delivery of a chronic disease prevention program. The method includes: receiving, by an integrator, an electronic record for a participant; interrogating, by the integrator, a database of community based organizations (CBOs); selecting a particular CBO to provide a chronic disease prevention program for the participant; enrolling the participant in the program offered by the selected CBO; updating the participant's electronic record maintained by the integrator in an electronic database as the participant progresses through the program; upon completion of the program by the participant, submitting to a health plan administrator, by the integrator, a claim for payment; and transmitting payment to the selected CBO, the payment corresponding to the provision by the selected CBO of the program to the participant.

In an embodiment, the method further includes storing the participant's electronic record in the electronic database maintained by the integrator.

In an embodiment, the method further includes providing a software tool including a user interface to the selected CBO to facilitate updating, by the selected CBO, the participant's electronic record.

In an embodiment, updating comprises monitoring the participant's compliance with the program.

In an embodiment, monitoring comprises determining and recording at least one of the participant's attendance, weight, and level of physical activity.

In an embodiment, updating comprises a program coach directly entering the participant's compliance information into the participant's record using the user interface.

In an embodiment, receiving comprises receiving a plurality of electronic records for a plurality of respective participants from at least two of the following sources: employers, medical providers, health systems, health plans, members, network providers, and CBOs.

In an embodiment, interrogating comprises comparing the participant's availability to class schedules for a plurality of CBOs.

In an embodiment, interrogating further comprises comparing the participant's address to class locations for a plurality of CBOs.

In an embodiment, the method further includes receiving compensation for the claim by the integrator responsive to submitting the claim for payment.

In an embodiment, the method further includes confirming, to a provider from whom the participant was referred, that the participant successfully completed the program.

In an embodiment, receiving comprises receiving one of biometric and survey data as part of the participant's record.

In an embodiment, the method further includes algorithmically monitoring aggregate biometric versus survey data for a plurality of participants.

In an embodiment, the method further includes submitting to a health plan administrator, by the integrator, a claim for partial payment upon completion of a program milestone by the participant.

A system is also provided for linking a patient with a prevention program. The system includes an integrator computer configured to: create and store an electronic record for a participant in a first database; search a second database of community based organizations (CBOs) using information obtained from the record; select a particular CBO to provide the prevention program to the participant; enroll the participant in the program offered by the selected CBO; update the record as the participant progresses through the program; and submit a claim for payment to a health plan administrator upon completion of the program by the participant.

In an embodiment, the integrator computer is further configured to transmit payment to the selected CBO for providing the program to the participant.

In an embodiment, the integrator computer is further configured to facilitate updating, by the selected CBO, of the participant's electronic record, wherein updating comprises monitoring the participant's compliance with the program.

In an embodiment, the integrator computer is further configured to compare the participant's availability and address to class schedules and locations for a plurality of CBOs.

Computer code stored in a non-transient medium for implementing, when executed by a processing system associated with an integrator computer, is also provided for performing the steps of: creating an electronic record for a participant; selecting a particular community based organization (CBO) from a plurality of CBOs using information from the record; enrolling the participant in a disease prevention program offered by the selected CBO; updating the record as the participant progresses through the program; and submitting a claim for payment to a health plan administrator upon completion of the program by the participant.

In an embodiment, the computer code is further configured to algorithmically monitor aggregate biometric and survey data for a plurality of participants

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed:

1. A method performed by a computer system for facilitating the delivery of a chronic disease prevention program, the method comprising:
receiving, by an integrator, an electronic record for a participant;
interrogating, by the integrator, a database of community based organizations (CBOs);
selecting a particular CBO to provide a chronic disease prevention program for the participant;
enrolling the participant in the program offered by the selected CBO;
updating the participant's electronic record maintained by the integrator in an electronic database as the participant progresses through the program;
upon completion of the program by the participant, submitting to a health plan administrator, by the integrator, a claim for payment; and
transmitting payment to the selected CBO, the payment corresponding to the provision by the selected CBO of the program to the participant.

2. The method of claim 1, further comprising
storing the participant's electronic record in the electronic database maintained by the integrator.

3. The method of claim 1, further comprising:
providing a software tool including a user interface to the selected CBO to facilitate updating, by the selected CBO, the participant's electronic record.

4. The method of claim 3, wherein updating comprises monitoring the participant's compliance with the program.

5. The method of claim 4, wherein monitoring comprises determining and recording at least one of the participant's attendance, weight, and level of physical activity.

6. The method of claim 5, wherein updating comprises a program coach directly entering the participant's compliance information into the participant's record using the user interface.

7. The method of claim 1, wherein receiving comprises receiving a plurality of electronic records for a plurality of respective participants from at least two of the following sources: employers, medical providers, health systems, health plans, members, network providers, and CBOs.

8. The method of claim 1, wherein interrogating comprises comparing the participant's availability to class schedules for a plurality of CBOs.

9. The method of claim 8, wherein interrogating further comprises comparing the participant's address to class locations for a plurality of CBOs.

10. The method of claim 1, further comprising:
responsive to submitting the claim for payment, receiving compensation for the claim by the integrator.

11. The method of claim 1, further comprising:
confirming, to a provider from whom the participant was referred, that the participant successfully completed the program.

12. The method of claim 1, wherein receiving comprises receiving one of biometric and survey data as part of the participant's record.

13. The method of claim 12, further comprising algorithmically monitoring aggregate biometric versus survey data for a plurality of participants.

14. The method of claim 1, further comprising:
submitting to a health plan administrator, by the integrator, a claim for partial payment upon completion of a program milestone by the participant.

15. A system for linking a patient with a prevention program, the system comprising an integrator computer configured to:
create and store an electronic record for a participant in a first database;
search a second database of community based organizations (CBOs) using information obtained from the record;
select a particular CBO to provide the prevention program to the participant;
enroll the participant in the program offered by the selected CBO;
update the record as the participant progresses through the program; and
submit a claim for payment to a health plan administrator upon completion of the program by the participant.

16. The system of claim 15, wherein the integrator computer is further configured to transmit payment to the selected CBO for providing the program to the participant.

17. The system of claim 15, wherein the integrator computer is further configured to facilitate updating, by the selected CBO, of the participant's electronic record, wherein updating comprises monitoring the participant's compliance with the program.

18. The system of claim 15, wherein the integrator computer is further configured to compare the participant's availability and address to class schedules and locations for a plurality of CBOs.

19. Computer code stored in a non-transient medium for implementing, when executed by a processing system associated with an integrator computer, the steps of:
creating an electronic record for a participant;
selecting a particular community based organization (CBO) from a plurality of CBOs using information from the record;
enrolling the participant in a disease prevention program offered by the selected CBO;
updating the record as the participant progresses through the program; and
submitting a claim for payment to a health plan administrator upon completion of the program by the participant.

20. The computer code of claim 19, further configured to algorithmically monitor aggregate biometric and survey data for a plurality of participants.
